(19) United States
(12) Patent Application Publication
(10) Pub. No.: US 2010/0272495 A1
(43) Pub. Date: Oct. 28, 2010

(54) CHALK HOLDER WITH A RESILIENT LATCH ELEMENT

(75) Inventor: Karel Srnênský, Kromeriz (CZ)

Correspondence Address: BUCHANAN, INGERSOLL & ROONEY PC, POST OFFICE BOX 1404, ALEXANDRIA, VA, 22313-1404, US

(73) Assignee: De Novo s.r.o., Kromeriz (CZ)

(21) Appl. No.: 12/747,317

(22) PCT Filed: Jun. 5, 2008
(86) PCT No.: PCT/CZ08/00061

§ 371 Date: Jun. 30, 2010

(30) Foreign Application Priority Data
Dec. 10, 2007 (CZ) PUV 2007-19484

(51) Int. Cl. B43K 23/00

(52) U.S. Cl. 401/88

(57) ABSTRACT

A chalk holder comprising a shaft and a slide formed by a chalk receiving part with a protruding spring-mounted upper arm extending through a longitudinal guide slot and provided with a button; the receiving part (4) has a protruding rigid bottom arm (5) mounted in the shaft (1) on at least one guide rail (7); the upper arm (6) has at least one tooth (9) on the upper side, which engages in grooves (13) perpendicular to the feed direction in the bottom side of an upper wall (12) of the shaft (1).

### TECHNICAL FIELD

The invention relates to a holder of rod-like objects such as chalks, leads or erasers. The holder comprises a shaft and a slide, which is formed by a receiving part for chalk fixation with a protruding spring-mounted upper arm extending through a longitudinal guide slot and provided with a button.

### PRIOR ART

Chalks used for writing, drawing or marking wipe off easily, soiling fingers and clothes of the user. In addition they are easy to break. An attempted solution to this problem is represented by the Czech utility model no 173321. The model relates to a holder with an inserted slide with a control button protruding from a longitudinal slot. On both sides of the slot there are crosswise open grooves for the control mechanism to engage in. The disadvantages of this design include the fact that dirt gets to the shaft through the grooves and the partitions between the grooves are easy to break.

DE utility model no 7025889 introduced a pencil or a crayon whose slide, in addition to the spring-mounted control arm, also includes a cylindrical stabilisation surface with longitudinal ribs. This design is ideal for holders with constant circular cross sections across the full length but not for holders of more complex shapes.

DE utility model no 7234900 describes a chalk holder with the slot extending from the front edge across a substantial part of the shaft. On the inside of the shaft next to the slot there are a number of stops. The slide in the designed shape does not firmly guide the chalk in the shaft and in addition this construction is only suitable for circular shafts.

The present invention aims at designing a chalk holder substantially limiting the abovementioned drawbacks of the known designs and allowing for variable designs of the shafts.

### SUMMARY OF THE INVENTION

The abovementioned task is solved by a chalk holder comprising a shaft and a slide formed by a chalk receiving part with a protruding spring-mounted upper arm extending through a longitudinal guide slot and provided with a button. A bottom rigid arm protrudes from the receiving part, mounted in the shaft on at least one guide rail, while the upper arm is provided with at least one tooth on the upper side engaging in grooves perpendicular to the direction of the feed in the bottom side of an upper wall of the shaft.

The bottom arm is provided with a beneficial stop for definition of the button travel.

The holder shaft can be triangular or square in section with the mouth formed by a circular, triangular or square chuck with a flexible sleeve.

An even more beneficial design comprises a double shaft with both parts connected together by a clamp connection.

### BRIEF DESCRIPTION OF THE DRAWING

The invention will be apparent to those skilled in the art from the following drawings in which:

FIG. 1 represents a preferred embodiment of the chalk holder in an axonometric view,

FIG. 2 shows a lengthwise cross section of the holder shaft from FIG. 1 and

FIG. 3 shows a crosswise section A-A of the object from FIG. 2.

### DETAILED DESCRIPTION OF PREFERRED EMBODIMENT

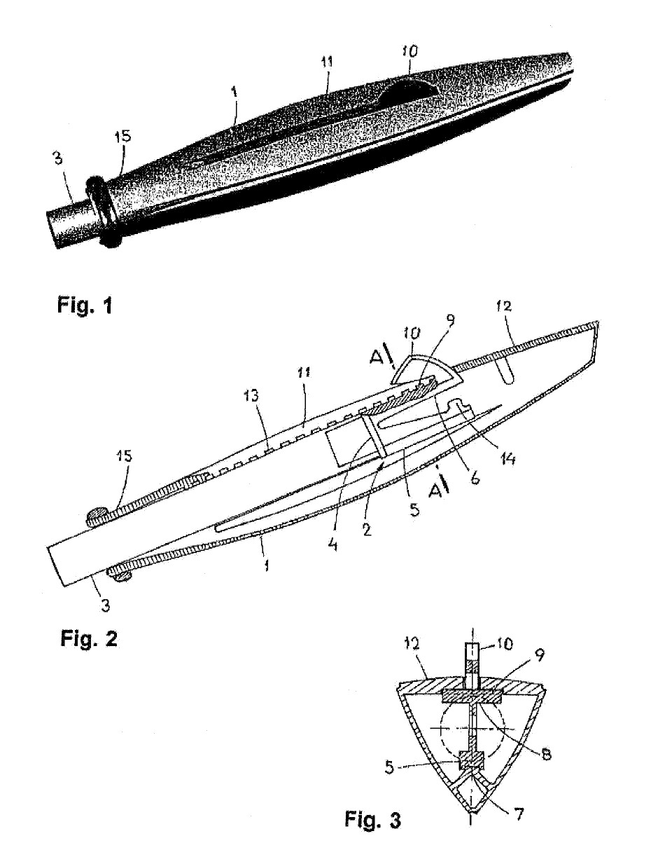

The chalk holder shown in FIGS. 1 to 3 comprises a thin-walled plastic shaft 1 and a slide 2, also made of plastic. The holder holds a circular chalk 3. The slide 2 consists of a receiving part 4 for the chalk 3 insertion and clamping. Two arms 5, 6 protrude from the receiving part 4. The bottom, rigid arm 5 is provided with a groove in the bottom sliding along a guide rail 7 formed inside the shaft 1. The upper arm 6 is spring mounted and consists of a rail 8 with teeth 9 and a button 10 passing through a longitudinal opening 11 in a upper wall 12 of the shaft 1. The teeth 9 in the upper side of the rail 8 engage in grooves 13 perpendicular to the lengthwise opening 11, and forming a row in the bottom side of the upper wall 12 of the shaft 1. In the bottom arm 5 there is a stop 14 defining the limit position of the upper arm 6 and thus also of the button 10. The shaft of the described holder is triangular with rounded edges and its mouth is formed by a circular chuck 15 with a flexible sleeve. Another variant designed for square chalks comprises a square cross section with rounded edges and a square chuck. The double shaft 1 has the two parts held together with a lengthwise clamping connection.

The chalk 3 is inserted in the receiving part 4 which clamps it. After pressing the button 10 down the button 10 can be used for setting the chalk extension 3 from the chuck 15. When the button is released the teeth 9 engage in their respective grooves 13 on the inside of the shaft arresting the chalk 3 in the chosen position.

1. A chalk holder comprising a shaft and a slide formed by a chalk receiving part with a protruding spring-mounted upper arm extending through a longitudinal guide slot and provided with a button, wherein a bottom rigid arm (5) protrudes from the receiving part, mounted in the shaft on at least one guide rail, while the upper arm is provided with at least one tooth on the upper side engaging in grooves perpendicular to the direction of the feed in the bottom side of an upper wall of the shaft.

2. The chalk holder according to claim 1, wherein the bottom arm is provided with a stop defining the button travel.

3. The chalk holder according to claim 1, wherein the shaft is triangular or square in section with a mouth consisting of a circular, triangular or square chuck with a flexible sleeve.

4. The chalk holder according to claim 1, wherein the shaft consists of two parts held together with a clamping connection.
